(19) United States
(12) Patent Application Publication
(10) Pub. No.: US 2014/0300486 A1
(43) Pub. Date: Oct. 9, 2014

(54) WIRELESS SENSOR DEVICE AND SYSTEM COMPRISING THE SAME

(71) Applicant: CREATOR TEKNISK UTVECKLING AB, Vikmanshyttan (SE)

(72) Inventors: Kjell Hummel, Nas (SE); Jon Lissmats, Borlange (SE); Anders Kjellberg, Falun (SE); Erling Pettersson, Sater (SE); Michael Gudmundsson, Ludvika (SE); Jerry Svedlund, Hedemora (SE)

(21) Appl. No.: 14/354,612

(22) PCT Filed: Oct. 23, 2012
(86) PCT No.: PCT/SE2012/051137

§ 371 Date: Apr. 28, 2014

(30) Foreign Application Priority Data
Oct. 26, 2011 (SE) 1150994-0

(51) Int. Cl. G08C 17/02

(52) U.S. Cl. CPC G08C 17/02
USPC 340/870.01

(57) ABSTRACT

A wireless sensor device (10) for a high-voltage environment, which device (10) comprises a housing (12), a control unit (18) for monitoring one or more variable(s) (T) and a power supply unit (20), wherein the housing (12) is designed such that an electric field (E) is minimized and the communication unit (16) is arranged partly inside the housing (12).

### FIELD OF THE INVENTION

The present invention relates to a wireless sensor device. More specifically, the present invention relates to a wireless sensor device for a high-voltage environment such as power production, transmission and distribution, as well as to power systems for railways. The present invention is also related to a system including a plurality of such sensor devices.

### BACKGROUND OF THE INVENTION

Today, high voltage applications such as high voltage systems with switchgear are known. In particular switchgear containing separate circuit breakers and disconnectors, or combined units with so-called “disconnecting circuit breakers” are used for instance in power sub-stations. In short, a disconnector is a mechanical power switch.

By the term “high voltage” is herein meant a voltage typically ranging from 6 kV-1400 kV. Currents can be as high as say 6 000 A, but are typically not higher than 2 000-3 000 A in such high voltage applications. These high currents may give rise to high temperatures in a disconnector due to increasing resistance of the disconnector, in particular if the disconnector is inferior, or worn out. Because of that, disconnectors, or other mechanical parts, through which high currents flow, or which are otherwise influenced by high currents in operation are exchanged, sometimes long before they eventually are worn out, thus reducing operational time thereof significantly. This of course is cumbersome and expensive because of too-early exchange of the mechanical parts.

Today, to be able to extend operational time of disconnectors, or other mechanical parts through which high currents flow, temperatures in disconnectors and other mechanical parts through which high currents flow in operation are measured, for instance by means of thermo photographing typically a few times per year of operation. A drawback with thermo photographing is that since this is a cumbersome and expensive method frequent measuring of temperature in disconnectors, or other mechanical parts cannot be achieved because of practical and economical reasons. During exchange of disconnectors or other mechanical parts power has to be shut down, which is another drawback since availability is decreased due to the power shut down.

Herein, the term “unavailability” refers to the fraction of time electric power is not available. One failure that is possible when the disconnector temperature in a switchgear has increased is that the disconnector has degenerated so much that finally an open arc develops, leading to a catastrophic failure and outage of the power delivery which leads to a collapse of at least part of the switchgear. Thus, temperature monitoring of disconnectors, or other mechanical parts in switchgear is of great importance.

Conventional sensor devices including temperature sensor devices typically suffer from problems due to corona effects, or sparking because of the high voltage environment. In fact, they cannot be used at all since sparking or corona effects destroy the sensor devices, or at least impair measurements.

Thus, there are a number of problems with measuring a parameter such as temperature in a high voltage environment, and in particular to continuously monitor the parameter.

According to our best knowledge, exchange of sensor devices in operation without shutting down power is also impossible with prior art sensor devices.

Thus, there is also a need to be able to do this, to be able to increase availability for instance.

### SUMMARY OF THE INVENTION

An object of the present invention is to provide a sensor device for measuring a parameter such as temperature in a high voltage environment, and in particular to continuously monitor the parameter during operation.

According to an embodiment of the present invention, there is provided a sensor device for a high-voltage environment and arranged to communicate wirelessly with a central unit. The wireless sensor device comprises a housing surrounding a control unit for measuring and/or monitoring one or more parameter(s) such as temperature, a communication unit comprising an antenna or optical communication means, and a power supply unit. The housing is made of metal and designed to conduct current such that an electric field and/or voltage is minimized and the communication unit comprises an antenna or optical communication means arranged inside the housing, or being integrated with the housing, wherein the communication unit has no parts projecting outside the housing.

In this way, there is provided a wireless sensor device suitable for a high voltage environment such as mounting on a disconnector, which sensor device does not suffer from problems due to corona effects, or sparking because of the high voltage environment, since the sensor device has no projecting parts, and is designed to resist high electric fields and/or voltages because of a round design having no sharp edges.

As with all measuring or monitoring, a reason for temperature measuring or monitoring is to avoid failures by giving an alarm before failure develops into a fault. The alarm should be early enough to make useful precautions possible at a suitable moment. Thus, frequent, or continuous temperature monitoring is a great advantage. This is achieved by means of the present invention.

Since mechanical parts through-flown by high current can be monitored wirelessly by the inventive device continuously, reliability can be increased due to the ability to avoid interrupts, since failures with these mechanical parts can be monitored as an increase in temperature in advance.

The inventive sensor device can also be exchanged during operation such that power does not have to be shut down. This can be accomplished by means of a so-called conventional “hot-stick”, which basically is an insulated pole allowing a service person to mount the sensor device during operation. In this way, unavailability is further minimized since power does not have to be shut down.

Typically, the sensor unit comprises or is arranged to communicate with a temperature sensor, such as an infrared sensor for measuring or monitoring parameters such as temperature outside and inside the housing.

According to another embodiment of the present invention, the control unit is arranged to generate one or more alarm(s) triggered by a monitored parameter(s) such as outside temperature (T_{outside}) exceeding a set threshold value.

In this way, long term monitoring, over years, can be achieved with automatic or manual alarm generation. Other advantages with the inventive sensor device are small size, high accuracy, low ageing and affordable price. It is important that price is affordable since a high number of sensor devices, say 100 per sub station can be required.

According to an embodiment of the present invention, there is also provided a sensor device system including a plurality of sensors, arranged to communicate with a central unit, the central unit being arranged to communicate with a user via a user interface such as a PC (Personal Computer) having access to the Internet, for running a web-based program for communicating with and controlling the sensor devices.

### BRIEF DESCRIPTION OF THE DRAWINGS

The features and advantages of the present invention will become further apparent from the following detailed description and the accompanying drawing, of which:

FIG. 1a shows a perspective view of a disassembled wireless sensor device for application in a high-voltage environment according to an embodiment of the present invention; FIG. 1b is a perspective view of the same sensor device as in FIG. 1a assembled; FIG. 1c is a rear view of the same sensor device as shown in FIG. 1b.

FIG. 2 shows the wireless sensor device as shown in FIG. 1 mounted on a disconnector;

FIG. 3 shows a sensor device system, according to an embodiment of the present invention, including a central unit for communication with the wireless sensor device shown in FIG. 1a-c and FIG. 2 and an operator via a web interface; and

FIG. 4 shows a chart of temperature monitoring via web interface by means of the inventive sensor device and system.

### DETAILED DESCRIPTION

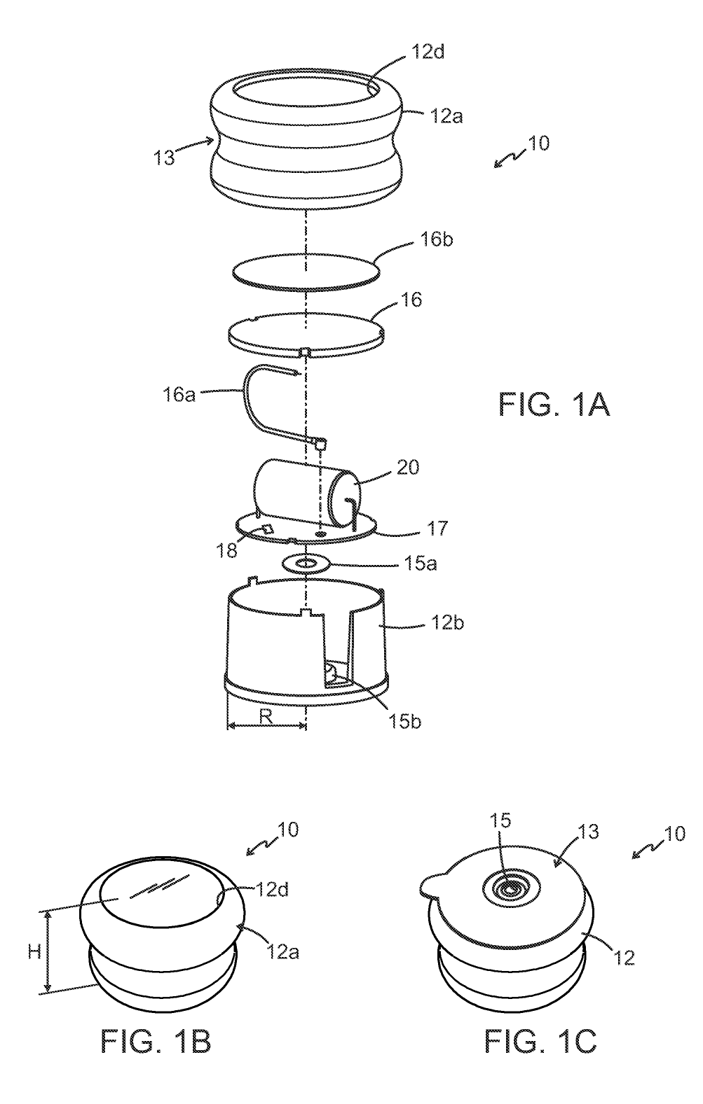

Referring now to FIG. 1a, which shows a perspective view of a disassembled sensor device according to an embodiment of the present invention, the principle of the present invention will be described as follows.

FIG. 1a shows a wireless sensor device 10 according to an embodiment of the present invention suitable for application in a high-voltage environment, or medium voltage environment, such as mounting the sensor device 10 on a disconnector (not shown in this figure) in a power sub station (not shown). The sensor device 10 comprises a housing 12 at least partly surrounding a communication unit 16, a control unit 18 for measuring and/or monitoring one or more parameter(s) such as temperature outside T_{outside} the housing 12 by means of temperature sensor 15 (See FIG. 1C). Typically, the temperature sensor 15 is arranged to also measure temperature inside T_{inside}, the housing 12. The communication unit 16 typically comprises an antenna and a combined receiver/transmitter, a so-called “transceiver” (not shown explicitly because of simplicity), for wireless communication with an external central unit (not shown). In this figure, the communication unit 16 is shown as an antenna part, herein a disc provided with metal. The transceiver can alternatively be arranged partly or completely in the control unit 18 or be arranged to communicate with the same. The sensor device 10, which is a self-power supplied device 10, further comprises a power supply unit 20, herein a long-life battery suitable having say 10 years of operation provided sampling each 10 minute, for powering all units 15, 16, 18. The temperature sensor 15, the communication unit 16, the control unit 18 and the power supply unit are coupled to each other. The housing 12 typically comprising a cover 12a, a base plate 12b is round and made of metal such as aluminum with or without surface treatment, or stainless steel and is designed with no sharp edges or the like such that an electrical field E (or in other words voltage) is minimized. The housing 12 also comprises an antenna part 16. Over the antenna part 16, there is further provided an over layer 16b for instance made of plastics, or any other suitable material. Typically, the over layer 16b is provided with text or other symbol(s). The choice of material for the housing is typically a matter of ability to be easily machined. Thus, often aluminum is selected for the cover 12a, and the base plate 12b. Because there are no sharp edges of the housing 12, corona effects will be reduced, or not be present at all despite the high voltage environment surrounding the sensor device 10, and a wireless sensor device 10 is provided, avoiding high voltage environment problems. This has been confirmed in numerous experiments. The control unit 18 can be implemented by means of a programmable processor and corresponding memory controlled by software, or by means of hardware only. Typically, the control unit 18 and the power supply 20 are provided on a printed circuit board 17. Also the communication unit 16 comprising electronics, or circuitry and/or software for communication and the antenna part are typically provided on or connected to the printed circuit board 17.

The control unit 18 in the sensor device 10 can have several functions. For instance, it 18 controls the temperature sensor 15, and any additional sensor (not shown) if any, it controls communication with the external central unit 30, it may mix temperature information with sensor device 10 identity information, and it controls power supply from the power supply unit 20. An example of electronics can be surface mounted integrated circuits suitable because of the small size of the sensor housing 12.

A grip 13 is also provided in the middle of the two torroids for gripping by a mounting tool carried by means of the hot stick (not shown). A volume of the housing 12 is selected such that a resonant cavity loaded (slot) antenna 16 is provided for generating radio waves for communication with the external central unit 11. The entire housing 12 will act as an antenna. The antenna part 16 can be an antenna pcb 16 and is typically embodied as an antenna arranged inside the housing 12, or a slot-antenna being integrated with the housing 12, and arranged on the printed circuit board 17. The antenna pcb 16 can be connected to the circuitry (not shown explicitly) of the printed circuit board 17 by means of a conductor 16a such as a coaxial cable, or flexible cable. The coaxial cable 16a can be connected permanently or be releasable. Typically the conductor 16a is impedance matched with the circuitry and the antenna part 16.

Another type of antenna such as a dipole antenna, or even a patch antenna, can be used instead than described above, provided that no parts project outwards the housing 12. In case a dipole antenna is provided holes may have to be provided in the housing 12. Parts projecting outside the housing 12 would suffer from corona effects and sparking in the high voltage environment and is therefore not suitable. A patch antenna for instance, as used in presently known sensor devices would not work, since corona effects would destroy the sensor device.

Instead of an antenna, the communication unit 16 can be arranged for optical communication with the receiver 11. For instance an IR-LED (infrared light-emitting diode) can be used as a transmitter to send temperature data to an integrated IR-receiver.

FIG. 1b shows a perspective view of the same sensor device as in FIG. 1a but assembled. The over-layer 16b, which can be a circular disc having a diameter designed to fit into the cover 12a is mounted somewhat lower than the edges of the surrounding cover. In this way, a spark hitting the sensor device will more likely hit an edge 12d (See also FIG. 1a) of the cover 12a instead of the over-layer 16b or the electronics within the housing. Typical dimensions of the housing 12 are a few centimeters of height H, say 3 cm, and a corner radius being large enough of say 10 mm. Most of the surfaces of the outside of the housing 12 are convex, and in particular having a large enough radius, which reduces sparking/corona problems in high voltage environments. The radius/height ratio R/H determines the volume V.

The volume V is selected to avoid corona effects, but a smallest possible volume Vₘᵢₙ, is required according to radio requirements.

In this particular embodiment, the housing 12 is designed as two torroids facing each other, but also other round designs having a particular volume V, corresponding to a particular radius R and height H, and being designed without projecting parts and/or sharp edges can be employed instead. Numerous calculations and experiments have show that a housing 12 being about 30 mm in height H, having a corner radius of about 5 mm is influenced by a field strength of about 10 kV/m, which is below the limit for corona problems which is about 17-18 kV in dry atmosphere.

The sensor 15 can be a conventional temperature sensor such as an infrared (IR) sensor for measuring or monitoring temperature outside Toutside and inside Tinside the housing 12. The IR sensor 15 looks though an eye 12e provided in the base plate 12b and monitors the temperature of the surface onto which the sensor device is mounted. Also other types of sensors can be applied including any suitable all-digital design type of sensor.

In this particular embodiment of the present invention, the base plate 12b comprises tape fastening means 13 for attaching the sensor device 10 to a disconnector (not shown). The tape fastening means 13 is typically a high quality industrial double adhesive surface tape of conventional type per se. An additional metal plate (not shown) can be mounted over the eye 12e and the temperature sensor 15 can then be of another type than infrared. A sealing plate 15a and/or or a sensor seat 15b (See FIG. 1a) can also be provided.

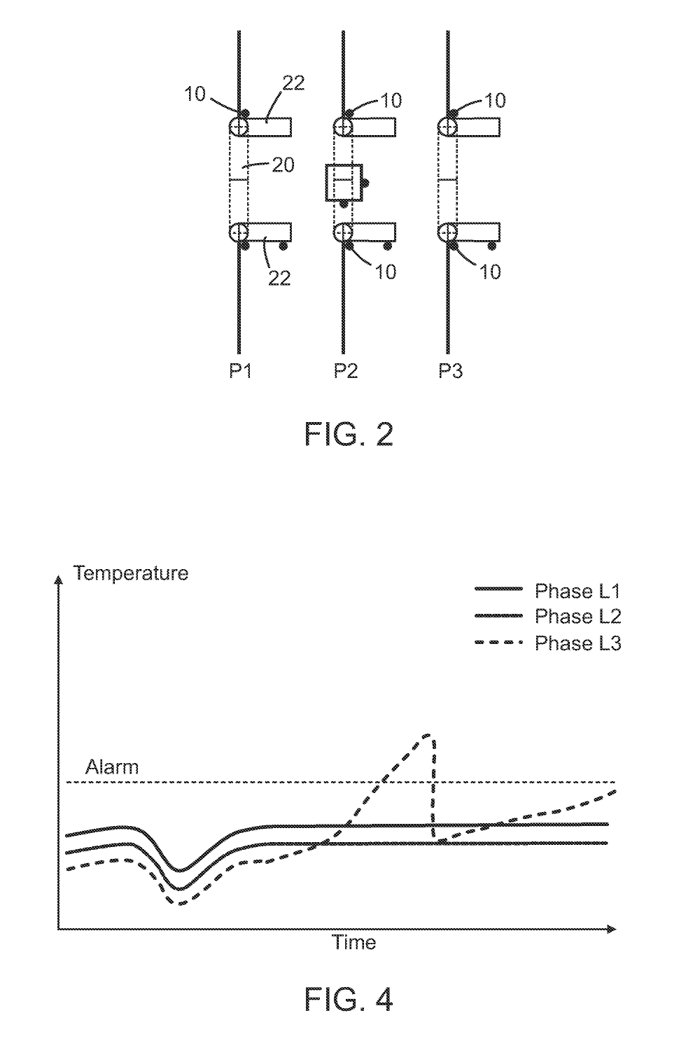

FIG. 2 shows a so-called “center break disconnector” 20, with its two swiveling post-insulators 22 for opening and closing a switch. Typically, the disconnector 20 and the wireless sensor device 10 are located in a high voltage environment such as a power sub station. The power sub-station and the disconnector 20 per se can be of any conventional type. The temperature measured or monitored is related to the flow of current through the disconnector 20 onto which the sensor device 10 is mounted.

FIG. 2 shows the wireless sensor devices 10 in FIG. 1 mounted on disconnectors 20 in a three phase system P1, P2, P3. Typically, a plurality of such as three sensor devices 10 are mounted on each disconnector 20, one on each swiveling arms 22 and one in the middle of the two swiveling arms 22 shown in disconnected position, i. e. switch open. Typically, each phase of the three phases P1, P2, P3 is provided with three sensor devices 10. Each phase, for instance the first phase P1, can have a temperature T1, differing from the other phases P2, P3 having temperatures T2, and T3, respectively. This will be further explained as follows.

Alternatively, the base plate comprises snap fastening means, for attaching the sensor device to a cable conductor (not shown). The snap fastening means can comprise one snap fastening element for holding the sensor device and one snap fastening element for fastening the snap fastening means on the cable conductor.

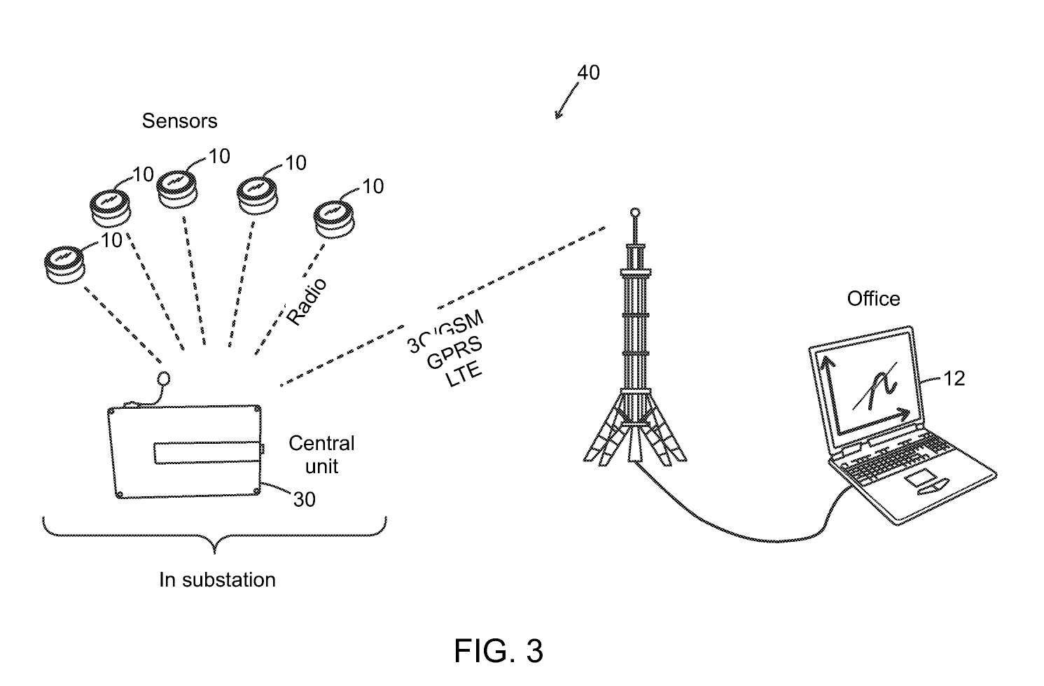

FIG. 3 shows a sensor device system 40 according to an embodiment of the invention including a plurality of sensors 10, typically mounted on a plurality of disconnectors (not shown because of simplicity), communicating via radio utilizing for instance 868, or 2,4 GHz MHz band with a central unit 30 located in a substation (not shown). The central unit 30 communicates with a user typically located elsewhere than in the substation via conventional wire or wireless communication such as 3G/GSM, GPRS, LTE. In this way, the user can be located almost anywhere physically having access to the sensor devices 10 via a user interface 42 such as a PC having access to the Internet for running a web-based program for communicating and controlling the sensor devices 10. Since the sensor devices 10 each has its own identity code that is sent together with the measurement information, several sensor devices 10 can send to the same central unit 30. The central unit 30 then sends the received measurement information to the user interface 42 where it is converted to a format for presentation to the user.

To keep the complexity of the electronics in the sensor devices 10 down, software in the central unit 30, and/or in the user interface 42 can be made more sophisticated to be able to identify the sensors 10 and calculate the temperatures T1, T2, T3, or difference(s) in temperature T1, T2, T3 between the different sensor devices, for generating an alarm.

The sensor devices 10 are typically user controlled by means of the web-based program of the user interface 42, wherein calculation of allowed current load of mechanical conductors such as disconnectors also take environmental conditions such as air temp, wind, sun into account. An asset data base can contain information about conductors and be part of the web-based program.

The software may also be arranged to compare the measured data with any selected alarm criterion. Alarms and historical data can be used for generating alerts and alarms to the user.

This is exemplified in FIG. 4, which shows a chart of temperature monitoring via web interface by means of the sensor device.

The simplest alarm criterion can be to provide an alarm for a temperature higher than one allowed for a particular type of disconnector, or any other mechanical part, typically given by the IEC standards, or any other standard. If a temperature, herein the temperature of the third phase L3 exceeds a set threshold value “alarm”, an alarm is generated automatically or manually. By the term “manually” is meant that the user alarms when a threshold value is exceeded.

Another, more sophisticated alarm can be to use the three phases P1, P2, P3 in the system to compare the temperatures between them T1, T2, T3.

The resistance pattern may differ between the three phases P1, P2, P3 when the disconnector is fresh, but normally not much, but may differ after some time of operation if any one of the phase will have higher resistance. Thus, the three phases P1, P2, P3 can be compared and an alarm can be triggered if any of the three phases exceeds the set threshold value “alarm”, or if the three phases P1, P2, P3 differ in temperature T1, T2, T3 more than another set threshold value. In this figure, it is shown how the third phase P3 exceeds a set threshold value “alarm”. Alarms may also be triggered by any other set threshold, or parameter, such as too high difference between temperature inside and outside a temperature sensor device.

If the temperatures T1, T2, T3 are monitored live, it is possible to conduct higher current than the disconnectors rated current Thus, the disconnector(s) can be overloaded under controlled conditions, controlled by the sensor device system 40. This can be at least partly implemented by means of software.

Thus, the present invention even provides temperature monitoring such that also intentional short periods of overloading is possible. The time constant for a switchgear may be about 30 minutes for a disconnector. This means that for a short period of time the switchgear may be loaded above its rated current without exceeding maximum allowed temperatures, especially if the overload starts from a level below the rated current. With the inventive temperature monitoring over-temperatures of the switchgear can be avoided. This can be at least partly implemented by means of software.

According to an alternative embodiment of the present invention, the sensor device 10 comprises a water-level indicator. An alarm signal is then sent to the central unit 30 in case of a water-level exceeding a set threshold value.

The power source can be a battery having an operational time of up to 12 years depending on how often parameters are measured/monitored and reported to the receiver. Longer time intervals between measurements/reporting increase battery operational time. A typical time interval is 10 minutes. Also transmitter power can be controlled such that optimum power or reduced transmitter power is used if possible.

Alternatively, since measurement is of importance only when current is flowing in the mechanical part such as the disconnector arm 22, being measured/monitored, it is possible to use the alternating magnetic field surrounding the disconnector arm 22 to power the sensor device 10 by means of an induction power generator unit (not shown). This can be provided for instance by means of mounting a strip of transformer sheet around the disconnector arm 22 and through a coil. The coil provides an output voltage sufficient for the sensor device 10, provided the primary current is high enough, say >40 A (at 50 Hz). The induction power generator unit is typically designed to withstand high currents that can occur. Typically, the sensor electronics in the control unit 18 rectifies and regulates the power supply voltage from the coil. Alternative arrangements may include coils being arranged essentially perpendicular to each other.

While throughout the above description the technology has been described as pertaining to a sensor device for monitoring temperature for use on a disconnector, it is fully contemplated herein to be able to carry out the embodiments described herein on any parameter to be monitored or measured in a high voltage environment. Accordingly, the sensor device as it is mentioned above should be considered as no more than an embodiment of the presently described device.

The foregoing detailed description is intended to illustrate and provide easier understanding of the invention, and should not be construed as limitations. Alternative embodiments will become apparent to those skilled in the art without departing from the spirit and scope of the present invention.

1. A wireless sensor device for a high-voltage environment, and arranged to communicate wirelessly with a central unit, which device comprises a housing surrounding a control unit for monitoring one or more parameter(s) such as temperature and a power supply unit, wherein the housing is made of metal and designed such that an E-field is minimized and the communication unit is arranged at least partly inside the housing.

2. The wireless sensor device according to claim 1, wherein the communication unit comprises an antenna being integrated with the housing.

3. The wireless sensor device according to claim 1, wherein the communication unit comprises an antenna being arranged inside the housing.

4. The wireless sensor device according to claim 1, wherein the control unit comprises or is arranged to communicate with a temperature sensor for measuring or monitoring temperature outside the housing.

5. The wireless sensor device according to claim 4, wherein the sensor is arranged to also measure an inside temperature.

6. The wireless sensor device according to claim 1, wherein the control unit is arranged to generate one or more alarm(s) triggered by a monitored parameter(s) such as outside temperature.

7. The wireless sensor device according to any claim 1, wherein the control unit is arranged to generate one or more alarm(s) triggered by historic parameters.

8. The wireless sensor device according to claim 1, wherein the sensor device is arranged to continuously monitor one or more parameter(s) such as outside temperature.

9. The wireless sensor device according to claim 2, wherein an antenna slot of the communication unit is arranged on a printed circuit board.

10. The wireless sensor device according to claim 1, further comprising a main circuit board comprising the control unit and a power source.

11. The wireless sensor device according to claim 1, wherein the base plate comprises fastening, attaching the sensor device.

12. The wireless sensor device according to claim 1, wherein the base plate comprises tape fastening means, for attaching the sensor device to a disconnector.

13. The wireless sensor device according to claim 1, wherein the base plate comprises snap fastening means, for attaching the sensor device to a cable.

14. A sensor device system including a plurality of sensors, arranged to communicate with a control unit, the control unit being arranged to communicate with a user via a user interface such as a PC having access to the Internet, for running a web-based program for communicating and controlling the sensor devices, wherein each device comprises a housing surrounding a control unit for monitoring one or more parameter(s) such as temperature and a power supply unit, wherein the housing is made of metal and designed such that an E-field is minimized and the communication unit is arranged partly inside the housing.

15. The sensor device system according to claim 14, wherein the system is arranged to compare a temperature difference between at least two temperatures from one or more sensors and to generate an alarm if the temperature difference exceeds a set threshold.

16. The sensor device system according to claim 15, wherein the system is arranged to monitor the temperatures live, and arranged to overload the disconnectors such that it is possible to conduct higher current and use higher voltages than the disconnectors are allowed to do, or can in conventional power substations.
